(19) United States
(12) Patent Application Publication
(10) Pub. No.: US 2014/0301651 A1
(43) Pub. Date: Oct. 9, 2014

(54) METHOD AND DEVICE FOR PERFORMING SPATIAL FILTERING PROCESS ON IMAGE

(71) Applicant: Xiaomi Inc., Beijing (CN)

(72) Inventor: Bo Zhang, Beijing (CN)

(73) Assignee: Xiaomi Inc., Beijing (CN)

(21) Appl. No.: 14/138,144

(22) Filed: Dec. 23, 2013

Related U.S. Application Data
(63) Continuation-in-part of application No. PCT/CN2013/085851, filed on Oct. 24, 2013.

(30) Foreign Application Priority Data
Apr. 7, 2013 (CN) 201310118048.8

(51) Int. Cl. G06K 9/74

(52) U.S. Cl. CPC G06K 9/748
USPC 382/210

(57) ABSTRACT

The present disclosure discloses a method and a device for performing a spatial filtering process on an image, which belongs to computer technology. The method comprises: dividing a target image into a plurality of sections; setting a section consisting pixels with data that satisfies a preset condition respectively, among the plurality of sections, as a section to be processed; and performing a spatial filtering process on the section to be processed. By the present disclosure, efficiency of the spatial filtering process may be improved.

### CROSS REFERENCE TO RELATED APPLICATIONS

The present application is a Continuation-In-Part of International Application No. PCT/CN2013/085851, with an international filing date of Oct. 24, 2013, which is based upon and claims priority of Chinese Patent Application No. 201310118048.8, filed on Apr. 7, 2013, the entire contents of which are incorporated herein by reference.

### TECHNICAL FIELD

The present disclosure generally relates to computer technology, and more particularly, to a method and a device for performing a spatial filtering process on an image.

### BACKGROUND

Owing to the advancement of electronic technology and the rapid growth and popularization of digital photography and video, the image processing technology also develops rapidly. When people manage a large quantity of captured image data, they often perform various image processes on the image data depending on different requirements, for instance, performing a whitening treatment to a portrait and so forth.

Spatial filtering technology is a common technology of data processing, which performs a treatment and adjustment to data of respective pixels in an image (a separate image or a frame of a video) through filtering functions, so as to achieve certain objectives, such as smoothing, sharpening, oil painting effect, sketch effect, and etc.

Conventionally, when a spatial filtering process is performed on an image, a filtering algorithm may be selected according to a certain requirement, and a corresponding filtering function may be adopted to perform a point-by-point data process on all of the pixels of the entire image.

### SUMMARY

The embodiments of the disclosure provide a method and a device for performing a spatial filtering process on an image, so as to improve efficiency of the spatial filtering process.

According to a first aspect of the present disclosure, there is provided a method for performing a spatial filtering process on an image. The method comprises: dividing a target image into a plurality of sections; setting a section consisting pixels with data that satisfies a preset condition respectively, among the plurality of sections, as a section to be processed; and performing a spatial filtering process on the section to be processed.

According to a second aspect of the present disclosure, there is provided a device. The device comprises: a processor; and a memory for storing instructions executable by the processor; wherein the processor is configured to execute steps comprising: dividing a target image into a plurality of sections; setting a section consisting pixels with data that satisfies a preset condition respectively, among the plurality of sections, as a section to be processed; and performing a spatial filtering process on the section to be processed.

According to a third aspect of the present disclosure, there is provided a non-transitory computer readable storage medium. The non-transitory computer readable storage medium includes instructions, executable by a processor in a device, for performing a spatial filtering process on an image in the device, comprising: dividing a target image into a plurality of sections; setting a section consisting pixels with data that satisfies a preset condition respectively, among the plurality of sections, as a section to be processed; and performing a spatial filtering process on the section to be processed.

In the embodiments of the disclosure, a target image is divided into a plurality of sections. Among the plurality of sections, a section consisting pixels with data that satisfies a preset condition respectively, is set as a section to be processed, and a spatial filtering process is performed on the section to be processed. Accordingly, it is possible to perform the spatial filtering process only on certain sections of the target image that needs to be processed instead of performing a point-by-point data process on all of the pixels of the entire image. Thus, the time required for performing the spatial filtering process on sections that need not to be processed may be saved. Hence, efficiency of the spatial filtering process may be improved.

It should be understood that the descriptions above in general and hereinafter in detail are only for illustrative but not to limit the present disclosure.

### BRIEF DESCRIPTION OF THE DRAWINGS

In order to clearly illustrate the technical resolutions of the embodiments of the present disclosure, the accompanying drawings used in describing the embodiments are simply illustrated as follows. Obviously, the accompanying drawings are only a way of example to describe the present disclosure, and those skilled in the art can obtain other drawings accordingly without making any inventive effort.

FIG. 1 is an exemplary flowchart of a method for performing a spatial filtering process on an image according to an embodiment of the disclosure;

FIG. 2 is a illustrative view of the divided sections according to an embodiment of the disclosure;

FIG. 3 is a schematic block diagram of an apparatus for performing a spatial filtering process on an image according to an embodiment of the disclosure;

FIG. 4 is a schematic block diagram of a device for performing a spatial filtering process on an image according to an embodiment of the disclosure.

### DETAILED DESCRIPTION

The objectives, technical resolutions and advantages of the disclosure will become apparent through a further detailed description given hereinafter to the embodiments of the disclosure in conjunction with the accompanying drawings.

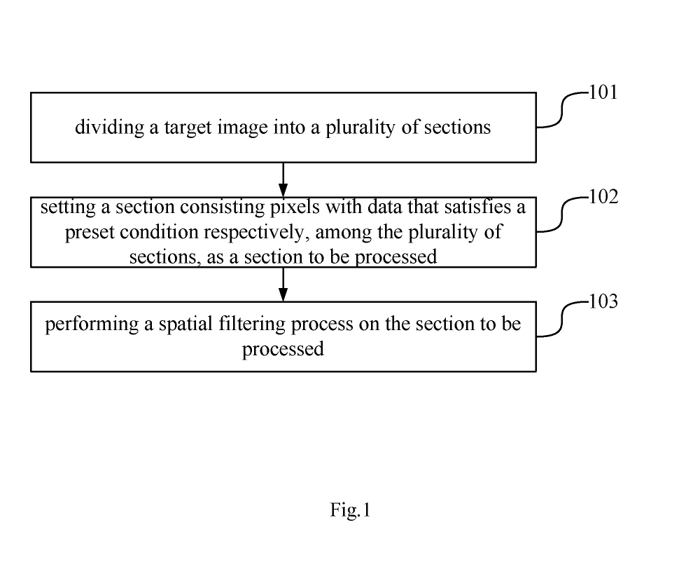

A method for performing a spatial filtering process on an image is provided by an embodiment of the disclosure. As illustrated in FIG. 1, a process flow of the method may include Step 101 dividing a target image into a plurality of sections, Step 102 setting a section consisting pixels with data that satisfies a preset condition respectively, among the plurality of sections, as a section to be processed, and Step 103 performing a spatial filtering process on the section to be processed.

In the embodiment of the disclosure, a target image is divided into a plurality of sections. Among the plurality of sections, a section consisting pixels with data that satisfies a preset condition respectively, is set as a section to be processed, and a spatial filtering process is performed on the section to be processed. In this way, it is possible to perform the spatial filtering process only on certain sections of the target image that needs to be processed. Thus, the time required for performing the spatial filtering process on sections that need not to be processed may be saved. Hence, the efficiency of the spatial filtering process may be improved.

A method for performing a spatial filtering process on an image is provided by an embodiment of the disclosure. The method may be implemented by a subject of any electronic device, e.g., a mobile terminal such as a mobile phone, a tablet PC, etc.

In conjunction with an exemplary embodiment, the process flow illustrated in FIG. 1 may be described in detail as follows.

Step 101 is dividing a target image into a plurality of sections. Wherein, the target image may be a separate image or a frame of a video.

In this step, the target image may be divided into the plurality of sections freely. For example, the target image may be divided into a plurality of rectangular sections. Compared with other section shapes or irregular section shapes, when a spatial filtering process is performed on a section adopting a rectangular shape, a large quantity of algorithm logic operations may be saved in processing pixels at the edges of the section. Hence, efficiency of the spatial filtering process may be improved. Further, the target image may be divided into a plurality of rectangular sections with horizontal and/or vertical straight lines.

For example, both the length and the width of the above-described rectangular section may be set as a positive integer power of 2 pixels (in image processing, length and width may be in units of number of pixels). The length may equal the width (i.e. the rectangle is a square), and the length may not equal the width. In this way, the processing of the following steps may be further simplified, so as to improve the processing efficiency.

The size of the divided section may be preset. It is disadvantageous to set the size of the section too small or too large. If the size is too small, the amount of the sections may become too large, and thus the amount of edges of the sections may become too large. This may cause a low accuracy of the spatial filtering process. Also, a large amount of sections may reduce the processing speed of Step 102. In view of this, it is also disadvantageous to set the size of the section too small. On the other hand, if the size is too large, the processing speed is nevertheless reduced because the spatial filtering process may be performed on a large number of pixels that need not to be processed. In view of this, it is also disadvantageous to adopt sections with a size too large. Therefore, it is desirable to select a moderate size for the sections, depending on the proportion of the area that needs to be processed and the whole target image.

In practical applications, an analysis may be performed on various types of images (images with similar size in proportion of areas to be processed may be classified as the same type) according to historic data or experimental data, so as to obtain a relationship between sizes of the sections and processing speeds. Hence, suitable sizes of sections may be selected with respect to different target images, so as to improve the processing speed. In addition, empirical data may also be adopted in setting the sizes of the sections.

Step 102 is setting a section consisting pixels with data that satisfies a preset condition respectively, among the plurality of sections, as a section to be processed.

Wherein, the preset condition may be set according to a specific requirement for an application scenario. For instance, in a skin beautifying application scenario, a smoothing process is performed on the skin, which needs to perform a spatial filtering process on the pixels that represent the skin. At this time, a section where the skin exceeds a certain percentage is set as a section to be processed. Therefore, the condition that needs to be satisfied by data of respective pixels may be set according to the features of the data of pixels that represent the skin. For another instance, in some filming scenario, a background may adopt a curtain of a certain color. When an image processing is performed on frames of a captured video, it needs to perform a spatial filtering process on pixels outside the curtain. At this time, a section where the curtain is less than a certain percentage is set as a section to be processed. Therefore, the condition that needs to be satisfied by data of respective pixels may be set according to the features of the data of pixels that represent the curtain.

Step 102 may be implemented in various approaches, two of which are given below as the preferred implementations.

In accordance with a first approach, with respect to each divided section, weight factors corresponding to respective pixels are determined according data of the corresponding pixels in the section and a preset standard for calculating the weight factor. The preset standard for calculating the weight factor is predefined based on a corresponding relationship between the data of the pixels in the section and the weight factors. If a sum of the weight factors of all of the pixels in the section reaches a preset first threshold, setting the section as the section to be processed.

Wherein, the weight factor corresponding to a pixel may be a parameter used to represent a possibility that the pixel is a pixel that needs to be processed. For example, the weight factor may be a probability value that represents that possibility. The preset standard for calculating the weight factor may be a corresponding relationship between a value range of the data and the weights. If the target image is a color image, the preset standard may a corresponding relationship between be a range of data value of a certain color channel and weight factors, and may also be a corresponding relationship between ranges of data values of multiple color channels and weight factors.

In practice, if the target image is a color image, data of respective color channels or data of a part of the color channels of a pixel may be obtained. If the target image is a monochrome image, then data of a pixel may be directly obtained. Accordingly, weight factors corresponding to respective pixels are determined according to the data of the pixel and the above-described preset standard which is used to define the corresponding relationship between the data and the weight factors. Then, a total weight factor is obtained by adding up the weight factors corresponding to respective pixels in the section, and is compared with the first threshold. If the total weight factor is equal to or greater than the first threshold, the section is set as a section to be processed. If the total weight factor is less than the first threshold, no treatment is needed, i.e., the section is not set as a section to be processed. The first threshold may be set to be a lower value, so as to improve the accuracy of the spatial filtering process and to improve the quality of the processed image.

In accordance with a second approach, with respect to each divided section, an amount of pixels with data matches a preset data value is determined. If the amount reaches a preset second threshold, the section is set as the section to be processed.

Wherein, the preset data value may be a preset data range, therefore, the data of a pixel having a preset data value means that the data of the pixel falls in the corresponding data range. If a target image is a color image, the preset data value may be a range of data value of one certain color channel, or ranges of data value of multiple color channels.

In practice, if a target image is a color image, data of respective color channels or data of a part of the color channels of a pixel may be obtained. If the target image is a monochrome image, data of a pixel may be directly obtained. With respect to each pixel in a section, a pixel have data that matches a preset data value will be counted, so as to determine an amount of the pixels in the section, whose corresponding data have the preset data value. Then, the amount is compared with a preset second threshold. If the amount is equals to or greater than the second threshold, the section is set as a section to be processed; and if the amount is less than the second threshold, no treatment is needed, i.e., the section is not set as a section to be processed. The second threshold may be set to be a lower value, so as to improve the accuracy of the spatial filtering process and to improve the quality of the processed image. For example, the section may be set as a square, with a length of 16 pixels. In this way, the above said number may be recorded by one byte, which may improve processing efficiency.

In an embodiment of the disclosure, in course of setting sections to be processed, some relatively isolated sections to be processed may be removed as sections not to be processed. This may be implemented by the following process: if a region is not adjacent to other sections to be processed, wherein the region is made up of a plurality of sections to be processed, which are connected to each other, and a surface area of the region is less than a preset third threshold, then setting the plurality of sections to be processed in the region as sections not to be processed.

The plurality of sections to be processed are connected to each other where it creates an isolated region that is not adjacent to other sections to be processed. If the surface of the isolated region is too small, it is possible that these sections to be processed have been set by misjudgment (under the above-described preset conditions, there is a possibility that some sections that need not to be processed are judged as sections that need to be processed). These sections to be processed may be set as sections not to be processed, i.e. these set sections to be processed may be cancelled.

Step 103 is performing a spatial filtering process on the section to be processed. Wherein, the spatial filtering process may be a recursive filtering process, such as recursive bilateral filtering process or recursive Gaussian filtering process, etc., or the spatial filtering process may also be conventional spatial filtering process, such as bilateral filtering process or Gaussian filtering process, etc.

When a spatial filtering process is performed, a separate spatial filtering process may be performed respectively on each section to be processed, i.e., a spatial filtering process is performed on each section to be processed as a separate image, or, a spatial filtering process is performed on a region made up of a plurality of sections to be processed which are connected to each other.

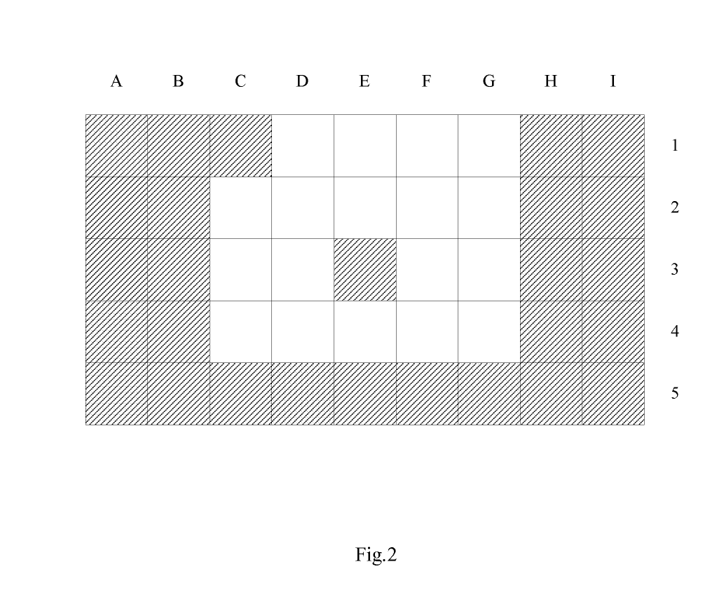

For example, if the filtering process includes a recursive filtering process, in order to improve efficiency, when Step 101 is performed, the target image may be divided into a plurality of rectangular sections with horizontal and/or vertical straight lines (as illustrated in FIG. 2). Then based on this assumption, Step 103 may include the following steps.

With respect to a plurality of sections to be processed sequentially connected in a transverse direction in the target image, a recursive filtering process in the transverse direction may be performed on a region made up of the plurality of sections to be processed; and the recursive filtering process in the transverse direction is performed on sections to be processed to which no section to be processed is adjacent in the transverse direction. With respect to a plurality of sections to be processed sequentially connected in a longitudinal direction in the target image, a recursive filtering process in the longitudinal direction may be performed on a region made up of the plurality of sections to be processed; and the recursive filtering process in the longitudinal direction is performed on sections to be processed to which no section to be processed is adjacent in the longitudinal direction.

No timing sequence is required among the above-described processes. That is, the recursive filtering process in the transverse direction may be performed first, or the recursive filtering process in the longitudinal direction may be performed first.

For instance, the target image is divided into a plurality of sections as illustrated in FIG. 2. The sections not shaded are set as sections to be processed. When the spatial filtering process is performed on the section to be processed, it is implemented as the following process.

The recursive filtering process in the transverse direction.

Row 1: skipping A1-C1 (i.e., no recursive filtering process is performed on these sections); the recursive filtering process in the transverse direction is performed on a region made up of D1-G1; skipping H1 and I1. Wherein, A1 refers to a section at the intersection of Row 1 and Column A, and so on.

Row 2: skipping A2 and B2; the recursive filtering process in the transverse direction is performed on a region made up of C2-G2; skipping H2 and I2.

Row 3: skipping A3 and B3; the recursive filtering process in the transverse direction is performed on a region made up of C3 and D3; skipping E3; the recursive filtering process in the transverse direction is performed on a region made up of F3 and G3; skipping H3 and I3.

Row 4: skipping A4 and B5; the recursive filtering process in the transverse direction is performed on a region made up of C4-G4; skipping H4 and I4.

Row 5: skipping all.

No timing sequence is required among the above-described processes for each line. They may be performed simultaneously, or may be performed in any sequence.

The recursive filtering processes in the longitudinal direction.

Column A: skipping all.

Column B: skipping all.

Column C: skipping C1; the recursive filtering process in the longitudinal direction is performed on a region made up of C2-C4; skipping C5.

Column D: the recursive filtering process in the longitudinal direction is performed on a region made up of D1-D4; skipping D5.

Column E: the recursive filtering process in the longitudinal direction is performed on a region made up of E1-E2; skipping E3; the recursive filtering process in the longitudinal direction is performed on a section E4; skipping E5.

Column F: the recursive filtering process in the longitudinal direction is performed on a region made up of F1-F4; skipping F5.

Column G: the recursive filtering process in the longitudinal direction is performed on a region made up of G1-G4; skipping G5.

Column H: skipping all.

Column I: skipping all.

No timing sequence is required among the above-described processes for each column. They may be performed simultaneously, or may be performed in any sequence.

In the embodiments of the disclosure, the target image is divided into a plurality of sections. Among the plurality of sections, a section consisting pixels with data that satisfies a preset condition respectively, among the plurality of sections, is set as a section to be processed, and a spatial filtering process is performed on the section to be processed. In this way, it is possible to perform the spatial filtering process only on certain sections of the target image that needs to be processed. Thus, the time required for performing the spatial filtering process on sections that need not to be processed may be saved. Hence, the efficiency of the spatial filtering process may be improved.

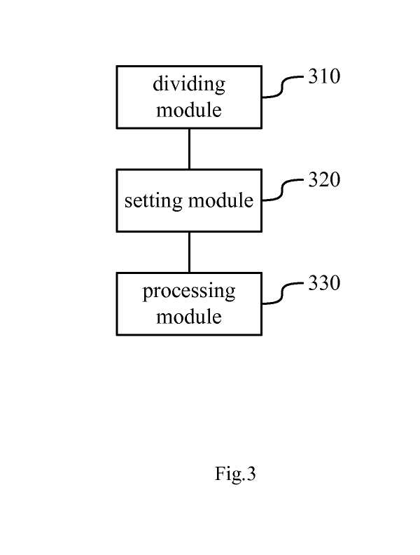

Based on the same technical conception, an apparatus for performing a spatial process on an image is provided by an embodiment of the disclosure. As illustrated in FIG. 3, the device includes a dividing module 310, a setting module 320 and a processing module 330.

The dividing module 310 is configured to divide a target image into a plurality of sections.

The setting module 320 is configured to set a section consisting pixels with data that satisfies a preset condition respectively, among the plurality of sections, as a section to be processed.

The processing module 330 is configured to perform a spatial process on the section to be processed.

For example, the dividing module 310 may be configured to divide the target image into a plurality of rectangular sections with horizontal and/or vertical straight lines.

For example, both the length and the width of the rectangular sections is a positive integer power of 2 pixels.

For example, the setting module 320 may be configured to as with regard to each divided sections, determine a weight factor with respect to each pixel according to data of the corresponding pixels in the section and a preset standard for calculating the weight factor, and if a sum of the weight factors of all of the pixels in the section reaches a preset first threshold, setting the section as the section to be processed.

For example, the setting module 320 may be configured to: with respect to each divided section, determine an amount of pixels whose data matches a preset data value, and if the amount of pixels in the section reaches a preset second threshold, setting the section as a section to be processed.

For example, after setting, the setting module 320 may further be configured to: if a region is not adjacent to other sections to be processed, wherein the region is made up of a plurality of sections to be processed, which are connected to each other, and a surface area of the region is less than a preset third threshold, then set the plurality of sections to be processed in the region as sections not to be processed.

For example, the spatial filtering process includes a recursive filtering process. The dividing module 310 is configured to divide the target image into a plurality of rectangular sections with horizontal and/or vertical straight lines. And the processing module 330 is configured to: with respect to a plurality of sections to be processed sequentially connected in a transverse direction in the target image, perform a recursive filtering process in the transverse direction on a region made up of the plurality of sections to be processed sequentially connected in the transverse direction; and, perform the recursive filtering process in the transverse direction on sections to be processed to which no section to be processed is adjacent in the transverse direction; and, with respect to a plurality of sections to be processed sequentially connected in a longitudinal direction in the target image, perform a recursive filtering process in the longitudinal direction on a region made up of the plurality of sections to be processed sequentially connected in the longitudinal direction; and, perform the recursive filtering process in the longitudinal direction on sections to be processed to which no section to be processed is adjacent in the longitudinal direction.

In the embodiment of the disclosure, a target image is divided into a plurality of sections. Among the plurality of sections, a section consisting pixels with data that satisfies a preset condition respectively is set as a section to be processed, and a spatial filtering process is performed on the section to be processed. In this way, it is possible to perform the spatial filtering process only on certain sections of the target image that needs to be processed. Thus, the time required for performing the spatial filtering process on sections that need not to be processed may be saved. Hence, the efficiency of the spatial filtering process may be improved.

It should be noted that, the spatial filtering process performed on an image by the apparatus for performing a spatial filtering process on an image according to the above-described embodiment, is only illustrated by example of divided functional modules as the above-mentioned. While in practice, the above functions may be assigned to different modules as desired, that is, the internal structure of the apparatus may be divided into different functional modules, so as to attain all or part of the functions described above. In addition, the method and the apparatus for performing a spatial filtering process on an image according to the above-described embodiments belongs to the same conception, therefore, the detailed implementing processes of the apparatus may refer to those of the embodiments of the method, and the detailed description of which are not given herein any more.

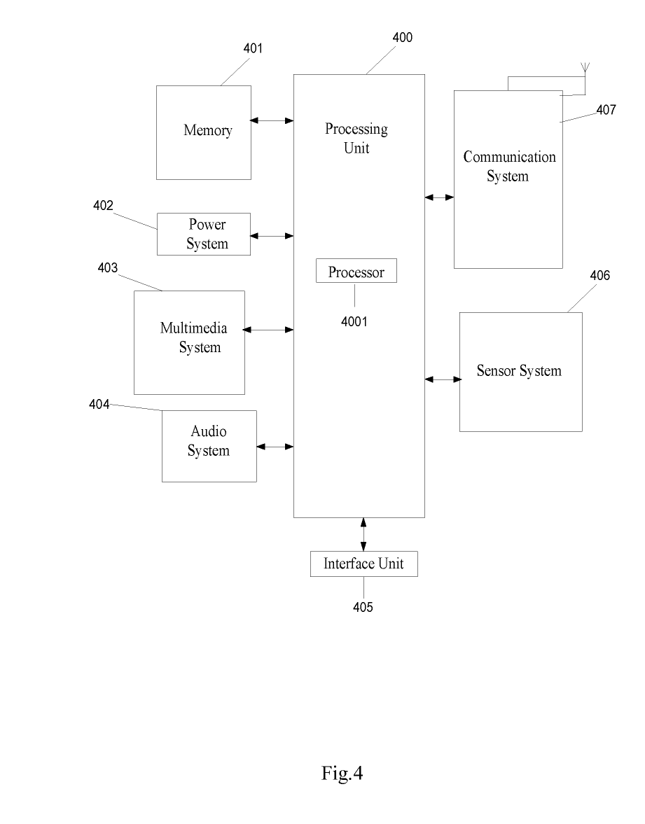

FIG. 4 is an exemplary block diagram of a device to which the method and apparatus for performing a spatial filtering process on an image are applied according to some embodiments of the present disclosure. According to the present disclosure, examples of such device may include mobile phones, computers, digital broadcast terminals, messaging devices, gaming consoles, tablets, pads, medical devices, exercise equipment, personal digital assistants, and the like.

Referring to FIG. 4, the device may include a processing unit 400, a memory 401, a power system 402, a multimedia system 403, an audio system 404, an interface unit 405, a sensor system 406 and a communication system 407. FIG. 4 illustrates the device as having various components, but it is understood that implementing all of the illustrated components is not required. Alternatively, the device may contain fewer or more components.

The processing unit 400 typically controls the overall operations of the device, such as the operations associated with display, calls, data communications, camera operations, and recording operations. The processing unit 400 may include one or more processors 4001 to execute instructions to perform all or part of steps described in the above embodiments.

Moreover, the processing unit 400 may include several modules which facilitate the interaction between the processing unit 400 and the other systems. For instance, the processing unit 400 may include a multimedia module to facilitate the multimedia interaction between the multimedia system 403 and the processing unit 400.

The memory 401 is generally used to store various types of data to support the processing, control, and storage requirements of the device. Examples of such data include instructions for any applications or methods operated on the device, contact data, phonebook data, messages, pictures, video, etc. The memory 401 may be implemented using any type (or combination) of suitable volatile and non-volatile memory or storage devices, including static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, or other similar memory or data storage devices.

The power system 402 provides power required by the various components of the device. The power system 402 may include a power management system, one or more power sources, and any other components associated with the generation, management, and distribution of power in the device.

The multimedia system 403 includes a screen providing an output interface between the device and the user. In some embodiments, the screen may comprise a liquid crystal display (LCD) and a touch panel (TP). If the screen includes the touch panel, the screen may be implemented as a touch screen to receive input signals from the users. The touch panel includes many touch sensors to sense touches, swipes, and gestures on the touch panel. The touch sensors may not only sense the boundary of the touch or the swipe action, but may also sense a period of time and a pressure associated with the touch or swipe action.

In some embodiments, the multimedia system 403 comprises a front camera and/or a rear camera. The front and rear camera may receive an external multimedia datum while the device is in a particular mode, such as a photographing mode or a video mode. The front or rear camera may be a fixed optical lens system or may have focus and optical zoom capability.

The audio system 404 is configured to output and/or input audio signals. Preferably, the audio system 404 includes a microphone (“MIC”) configured to receive an external audio signal while the device is in a particular mode, such as a call mode, a recording mode, and a voice recognition mode. The received audio signal may be further stored in the memory 401 or transmitted via one or more modules of the communication system 407. In some embodiments, the audio system 404 further includes a speaker or a receiver to output audio signals.

The interface unit 405 provides the interface between the processing unit 400 and peripheral interface modules, such as a keyboard, a click wheel, buttons, and the like. The buttons may include but are not limited to a home button, a volume button, a starting button, and a locking button.

The device may also have the sensor system 406, including one or more sensors to provide status assessments of various aspects of the device. For instance, the sensor system 406 may detect an open/closed status of the device, relative positioning of components (e.g., a display and a keypad) of the device, a change of position of the device or a component of the device, a presence or absence of user contact with the device, orientation or acceleration/deceleration of the device, and a change of temperature of the device.

The sensor system 406 may include a proximity sensor, which is configured to detect the presence of nearby objects without any physical contact. The sensor system 406 may also include a light sensor, such as CMOS or CCD image sensors, for use in imaging applications. In some embodiments, the sensor system 406 may also include an accelerometer sensor, a gyroscope sensor, a magnetic sensor, a pressure sensor, and a temperature sensor.

The device may include a communication system 407 configured with several commonly implemented communication components to facilitate communication with other devices. The communication system 407 typically includes one or more components which permit wireless or wired communication between the device and a communication network. The device may be accessed using any type (or combination) of suitable internet connection methods including WIFI, 2G, 3G, and other similar wireless or wired methods. Preferably, the communication system 407 also comprises one or more components to receive a broadcast signal and/or broadcast associated information from an external broadcast management entity via a broadcast channel. The broadcast management entity typically refers to a system which can transmit a broadcast signal and/or broadcast associated information. Preferably, the communication system 407 further comprises a near field communication (NFC) module to facilitate relatively short-range communications. Suitable technologies for implementing this module include radio frequency identification (RFID), infrared data association (IrDA), ultra-wideband (UWB), networking technologies commonly referred to as Bluetooth (BT), and other similar technologies.

Additional circuitry, including a combination of hardware circuitry and software, are, certainly, included to obtain the needed functionality described therein. These are not described in details as they would be readily apparent to those skilled in the art.

Those skilled in the art may acknowledge that all or part of the steps in the above embodiments may be implemented by a hardware or may be implemented in a related hardware instructed by instructions stored in a non-transitory computer readable storage medium. The computer can also include the device as defined in the present disclosure.

The non-transitory computer readable storage medium may use, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

For a software implementation, the embodiments described herein may be implemented with separate software modules, such as procedures and functions, each of which performs one or more of the functions and methods described herein. The software codes can be implemented with a software application written in any suitable programming language and may be stored in memory of the device.

The aforementioned methods can be implemented in a non-transitory computer readable storage medium recording computer-readable codes. The non-transitory computer readable storage medium includes all kinds of recording devices in which data readable by a computer system are stored. The non-transitory computer readable storage medium includes ROM, RAM, CD-ROM, magnetic tapes, floppy discs, optical data storage devices, and the like, as well as carrier-wave type implementations (e.g., transmission via Internet).

It should be understood by those skilled in the art that, all or part of the steps of the above embodiments may be implemented through hardware, or through a program that instructs a related hardware. The program may be stored on a computer-readable storage medium which may be read-only memory, magnetic or optical disks.

The foregoing are only preferred embodiments of the disclosure, and do not intend to limit the disclosure. Any variation, equivalent substitution and modification that fall within the spiritual and principle of the disclosure should be embraced by the protective scope of the disclosure.

What is claimed is:

1. A method for performing a spatial filtering process on an image, comprising:
dividing a target image into a plurality of sections;
setting a section consisting pixels with data that satisfies a preset condition respectively, among the plurality of sections, as a section to be processed; and
performing a spatial filtering process on the section to be processed.

2. The method according to claim 1, wherein dividing comprises:
dividing the target image into a plurality of rectangular sections with horizontal and/or vertical straight lines.

3. The method according to claim 2, wherein both a length and a width of the rectangular section comprise a positive integer power of 2 pixels.

4. The method according to claim 1, wherein setting comprises:
with respect to each divided section, determining a weight factor with respect to each pixel according to data of the corresponding pixels in the section and a preset standard for calculating the weight factor, and if a sum of the weight factors of all of the pixels in the section reaches a preset first threshold, setting the section as the section to be processed.

5. The method according to claim 1, wherein setting comprises:
with respect to each divided section, determining an amount of pixels whose data matches a preset data value, and if the amount of pixels in the section reaches a preset second threshold, setting the section as a section to be processed.

6. The method according to claim 1, wherein after setting, the method further comprises:
if a region is not adjacent to other sections to be processed, wherein the region is made up of a plurality of sections to be processed, which are connected to each other, and a surface area of the region is less than a preset third threshold, then setting the plurality of sections to be processed in the region as sections not to be processed.

7. The method according to claim 2, wherein performing a spatial filtering process on the section to be processed comprises:
with respect to a plurality of sections to be processed sequentially connected in a transverse direction in the target image, performing a recursive filtering process in the transverse direction on a region made up of the plurality of sections to be processed sequentially connected in the transverse direction; and
performing the recursive filtering process in the transverse direction on sections to be processed to which no section to be processed is adjacent in the transverse direction; and
with respect to a plurality of sections to be processed sequentially connected in a longitudinal direction in the target image, performing the recursive filtering process in the longitudinal direction on a region made up of the plurality of sections to be processed sequentially connected in the longitudinal direction; and
performing the recursive filtering process in the longitudinal direction on sections to be processed to which no section to be processed is adjacent in the longitudinal direction.

8. A device, comprising:
a processor; and
a memory for storing instructions executable by the processor;
wherein the processor is configured to execute steps comprising:
dividing a target image into a plurality of sections;
setting a section consisting pixels with data that satisfies a preset condition respectively, among the plurality of sections, as a section to be processed; and
performing a spatial filtering process on the section to be processed.

9. The device according to claim 8, wherein dividing comprises:
dividing the target image into a plurality of rectangular sections with horizontal and/or vertical straight lines.

10. The device according to claim 9, wherein both a length and a width of the rectangular section comprise a positive integer power of 2 pixels.

11. The device according to claim 8, wherein setting comprises:
with respect to each divided section, determining a weight factor with respect to each pixel according to data of the corresponding pixels in the section and a preset standard for calculating the weight factor, and if a sum of the weight factors of all of the pixels in the section reaches a preset first threshold, setting the section as the section to be processed.

12. The device according to claim 8, wherein setting comprises:
with respect to each divided section, determining an amount of pixels whose data matches a preset data value, and if the amount of pixels in the section reaches a preset second threshold, setting the section as a section to be processed.

13. The device according to claim 8, wherein the processor is configured to execute following step after the step of setting:
if a region is not adjacent to other sections to be processed, wherein the region is made up of a plurality of sections to be processed, which are connected to each other, and a surface area of the region is less than a preset third threshold, then setting the plurality of sections to be processed in the region as sections not to be processed.

14. The device according to claim 9, wherein performing a spatial filtering process on the section to be processed comprises:
with respect to a plurality of sections to be processed sequentially connected in a transverse direction in the target image, performing a recursive filtering process in the transverse direction on a region made up of the plurality of sections to be processed sequentially connected in the transverse direction; and
performing the recursive filtering process in the transverse direction on sections to be processed to which no section to be processed is adjacent in the transverse direction; and
with respect to a plurality of sections to be processed sequentially connected in a longitudinal direction in the target image, performing the recursive filtering process in the longitudinal direction on a region made up of the plurality of sections to be processed sequentially connected in the longitudinal direction; and
performing the recursive filtering process in the longitudinal direction on sections to be processed to which no section to be processed is adjacent in the longitudinal direction.

15. A non-transitory computer readable storage medium including instructions, executable by a processor in a device, for performing a spatial filtering process on an image in the device, comprising:
dividing a target image into a plurality of sections;
setting a section consisting pixels with data that satisfies a preset condition respectively, among the plurality of sections, as a section to be processed; and
performing a spatial filtering process on the section to be processed.

16. The computer readable storage medium according to claim 15, wherein dividing comprises:
dividing the target image into a plurality of rectangular sections with horizontal and/or vertical straight lines.

17. The computer readable storage medium according to claim 16, wherein both a length and a width of the rectangular section comprise a positive integer power of 2 pixels.

18. The computer readable storage medium according to claim 15, wherein setting comprises:
with respect to each divided section, determining a weight factor with respect to each pixel according to data of the corresponding pixels in the section and a preset standard for calculating the weight factor, and if a sum of the weight factors of all of the pixels in the section reaches a preset first threshold, setting the section as the section to be processed.

19. The computer readable storage medium according to claim 15, wherein setting comprises:
with respect to each divided section, determining an amount of pixels whose data matches a preset data value, and if the amount of pixels in the section reaches a preset second threshold, setting the section as a section to be processed.

20. The computer readable storage medium according to claim 15, wherein after setting, the process further comprises:
if a region is not adjacent to other sections to be processed, wherein the region is made up of a plurality of sections to be processed, which are connected to each other, and a surface area of the region is less than a preset third threshold, then setting the plurality of sections to be processed in the region as sections not to be processed.
